(19) United States
(12) Patent Application Publication
(10) Pub. No.: US 2014/0234473 A1
(43) Pub. Date: Aug. 21, 2014

(54) SOFTGEL ENCAPSULATED BALL INCORPORATING CHUM AS A FISH ATTRACTANT

(71) Applicant: Aaron Kapner, Yaphank, NY (US)

(72) Inventor: Aaron Kapner, Yaphank, NY (US)

(21) Appl. No.: 14/260,402

(22) Filed: Apr. 24, 2014

Related U.S. Application Data
(63) Continuation of application No. 12/856,937, filed on Aug. 16, 2010, now abandoned.
(60) Provisional application No. 61/267,596, filed on Dec. 8, 2009.
(60) Provisional application No. 61/234,172, filed on Aug. 14, 2009.

(51) Int. Cl. A01K 97/04

(52) U.S. Cl. CPC A01K 97/045
USPC 426/1

(57) ABSTRACT

Chum balls contain liquefied, dehydrated and/or freeze dried chum encapsulated in a water soluble ball (capsule). According to alternate embodiments, the chum ball may also include one or more of the following ingredients: a releasing agent such as sodium bicarbonate, a sinking agent such as magnesium, freeze dried plant matter, fish oil. An exemplary formula and a suitable machine for manufacturing are also disclosed. According to one embodiment, the releasing agent and the plant matter are incorporated into the capsule material.

### CROSS-REFERENCE TO RELATED APPLICATIONS

This application claims benefits from U.S. Provisional Patent Application No. 61/234,172, filed Aug. 14, 2009, and from U.S. Provisional Patent Application No. 61/267,569, filed Dec. 8, 2009, the complete contents of which are both hereby incorporated by reference herein.

### BACKGROUND OF THE INVENTION

1. Field of the Invention

This invention relates broadly to fishing. More particularly, this invention relates to methods of fishing that involve the use of chum and most particularly to methods for preparing chum for use in fishing.

2. State of the Art

A well known method of attracting fish to be caught is to use “chum”. Chum is a mixture of cut or ground bait that is dumped into the water to attract fish to the area where one is fishing. The fish are then caught using nets or baited hooks. One of the challenges of “chumming” is to use exactly the right amount of chum placed in exactly the right places. If too much chum is used or if it is spread too far or concentrated too much, fish will be attracted, eat the chum and then swim away without being caught.

### SUMMARY OF THE INVENTION

It is therefore an object of the invention to provide improved methods of chumming.

In accord with this object, the present invention provides a new method of chumming using a softgel encapsulated ball filled with a mixture of freeze dried and/or liquefied raw chum as well as other ingredients which improve the chumming experience. The ball is preferably made of a dissolvable skin and includes a sinking agent and a releasing agent as well as the chum. The sinking agent may be magnesium or the like and the releasing agent sodium bicarbonate or the like. The chum may include krill, worms, fish, squid, amphibians or other types of ingredients used traditionally to bait fish. Optionally, the freeze dried and/or liquefied chum may be processed into or incorporated into an oil. Further, the ball preferably includes dried sterilized plant matter such as seaweed, kelp, fresh water plants and algae. When the chum ball of the invention is dropped into water it sinks and dissolves releasing a controlled amount of chum into a specific place under water.

According to one aspect of the invention, the chum balls may be colored to attract certain desirable fish that are attracted to particular colors.

The releasing agent, in addition to promoting the dissolution of the chum, creates bubbles which further serve to attract fish from even farther distances.

The dried and detoxified plant matter serves as plant food for underwater plants, thereby improving the entire underwater ecosystem. This will ultimately improve the health of the fish and the health of the human consumers of the fish because it serves to detoxify the underwater plants.

The chum balls of the invention are easy to transport and store without refrigeration and have a very long shelf life. This provides the fisherman with a greater selection of chum throughout the year regardless of season.

The chum balls of the invention do not contain any toxic material, are completely biodegradable and environmentally safe. When the chum balls come in contact with water the shell will start to dissolve to disperse the taste and smell of the raw chum in the water.

The chum balls may be dropped or thrown into the water or they may be ejected using a device such as a sling-shot or a compressed air gun. The balls may also be formulated to dissolve at a predetermined depth. Allowing the balls to reach the ocean floor before dissolving can provide a distraction for crabs which will try to eat the balls, thereby releasing the chum and keeping the crabs occupied rather than eating the bait from the fisherman's hook.

When the chum balls dissolve (or are eaten by crabs) they produce a “fog” of chum in the water that is very effective at attracting fish. The chum balls can be anywhere from one to five inches in diameter depending on how they will be used.

Additional objects and advantages of the invention will become apparent to those skilled in the art upon reference to the detailed description taken in conjunction with the provided figures.

### BRIEF DESCRIPTION OF THE DRAWINGS

FIG. 1 is a cross sectional schematic view of a chum ball according to the invention; and

FIG. 2 is a simplified flow chart illustrating the method of making chum balls according to the invention.

### DETAILED DESCRIPTION

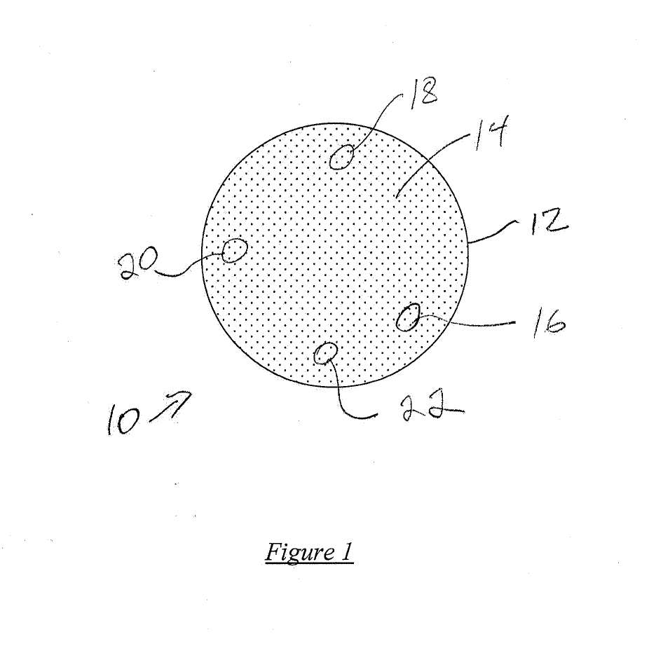

Turning now to FIG. 1, a chum ball 10 according to the invention includes a softgel water soluble ball (sphere) 12 containing either liquefied or freeze dried chum 14. The ball 12 may be made from pig skin, plant cellulose or any other material that will contain the chum but which dissolves in water. The chum may include krill, worms, fish, squid, amphibians or other types of ingredients used traditionally to attract fish. The ball 12 optionally includes one or more of the following ingredients: a releasing agent 16, a sinking agent 18, freeze dried plant matter 20, fish oil 22. A preferable releasing agent is sodium bicarbonate which is preferably homogenously mixed with the chum and any other ingredients. However, other suitable releasing agents could be utilized. A suitable sinking agent is magnesium or any other environmentally friendly material (e.g. earth metals or sand) having sufficient density to sink in water. The amount and density of sinking agent may be selected to determine the depth to which the ball will sink before dissolving. The freeze dried plant matter may include seaweed, kelp, fresh water plants and/or algae which have been sterilized or otherwise detoxified. The fish oil may be added to or processed from the chum.

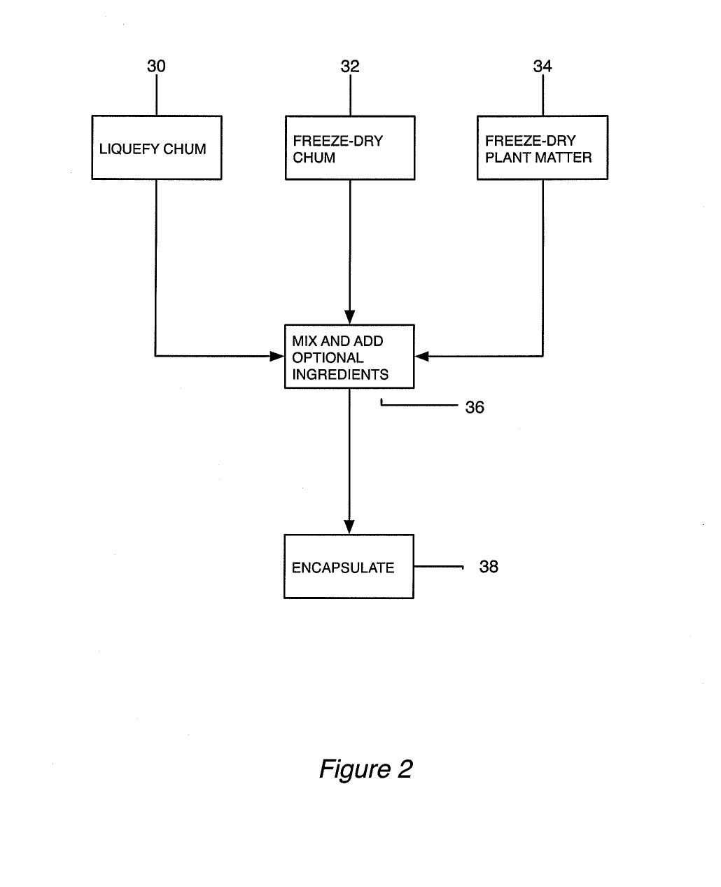

FIG. 2 illustrates, in simplified form, a method for producing the chum balls described above. The raw or live chum is either liquefied at 30, freeze dried at 32 or some liquefied chum is used and some freeze dried chum is combined with it. Preferably, plant matter is also freeze dried at 34 and combined with the chum and any other of the optional ingredients at 36. The combination is then encapsulated at 38 into a water soluble sphere or ball. Spheres are preferable because they are easy to store and can be propelled from a compressed air rifle such as a “paint ball gun”. However, other shapes may be acceptable.

A suitable apparatus and process for encapsulating material in a softgel capsule is disclosed in U.S. Pat. No. 5,735,105, issued Apr. 7, 1998 to Stroud et al., the complete disclosure of which is incorporated by reference herein.

A preferable freeze drying process is known as Lyophilization. Cryodesiccation is the actual dehydration process utilized and lyoprotectants are added to protect the freeze dried materials.

The process used to encapsulate the freeze dried materials is called the accogel process which can be performed with the apparatus of the, previously incorporated, Stroud et al. patent.

The freeze dried chum according to the invention is easier to handle, having no odor until dissolved, and has a longer shelf life than the liquefied chum. Both the liquefied and the freeze dried chum have the advantage that they attract fish (due to taste and smell) but unexpectedly do not satisfy the appetite of the fish since the chum is dispersed. This also unexpectedly results in the fish being more attracted to the fisherman's bait since their appetite has been enhanced but not satisfied by the chum.

As mentioned above, the size, contents, and color of the chum balls can be varied to achieve different results. Large, heavy and colorful chum balls will fall to the ocean floor and distract crabs. Different chum ingredients will attract different kinds of fish as will different color balls. By selecting the depth of dissolution of the chum ball, fish dwelling at different depths can be attracted.

The following recipe is appropriate for a 1.00 caliber chum ball approximately: 1.5 grams of liquefied chum (e.g. raw mackerel), 1.5 grams of freeze dried kelp/seaweed, 500 milligrams of sodium bicarbonate, and 500 milligrams of magnesium. Manufacturing is advantageously performed with batches of several thousand balls.

According to an alternate embodiment, the raw chum is liquefied using a process that does not alter the raw quality of the chum. The liquefied chum is encapsulated in a pigskin or other suitable animal skin or plant cellulose ball which can be formed with the sodium bicarbonate and the plant food being integrated with the pigskin. The amount of liquid chum encapsulated in the ball can be varied.

There have been described and illustrated herein several embodiments of a chum ball as well as methods and apparatus for making them. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as claimed.

What is claimed is:

1. A chum ball comprising:
a water soluble capsule; and
liquefied and/or freeze dried chum encapsulated in said capsule.

2. A chum ball according to claim 1, further comprising:
a releasing agent encapsulated in said capsule.

3. A chum ball according to claim 2, wherein:
said releasing agent includes sodium bicarbonate.

4. A chum ball according to claim 1, further comprising:
a sinking agent encapsulated in said capsule.

5. A chum ball according to claim 4, wherein:
said sinking agent includes magnesium.

6. A chum ball according to claim 1, further comprising:
freeze dried plant matter encapsulated in said capsule.

7. A chum ball according to claim 6, wherein:
said chum and said freeze dried plant matter are combined with the ratio 1:1.

8. A chum ball according to claim 1, further comprising:
fish oil encapsulated in said capsule.

9. A chum ball comprising:
a water soluble capsule;
liquefied and/or freeze dried chum encapsulated in said capsule; and
one or more items selected from the group consisting of a releasing agent, a sinking agent, freeze dried plant matter, and fish oil encapsulated in said capsule.

10. A chum ball according to claim 9, wherein:
said capsule is pigment with color.

11. A method for making a chum ball, comprising:
processing live or raw chum by liquefaction and/or freeze drying; and
encapsulating the processed chum in a water soluble capsule.

12. A method according to claim 11, further comprising processing plant matter and mixing the processed plant matter with the processed chum prior to encapsulating.

13. A method according to claim 12, wherein:
the processed chum and the processed plant matter are mixed with the ratio 1:1.

14. A method according to claim 12, further comprising:
mixing a releasing agent with the processed plant matter and the processed chum prior to encapsulating.

15. A method according to claim 14, further comprising:
mixing a sinking agent with the releasing agent, the processed plant matter and the processed chum prior to encapsulating.

16. A method according to claim 12, wherein:
the processing of the plant matter includes detoxifying it.

17. A chum ball comprising:
a water soluble capsule; and
liquefied raw chum encapsulated in said capsule, wherein
said capsule is partially made of processed plant matter and sodium bicarbonate.

18. A chum ball according to claim 17, wherein:
said chum does not fill the capsule.

19. A chum ball according to claim 17, wherein:
the weight ratio of chum to plant matter to sodium bicarbonate is approximately 3:3:1.

20. A chum ball according to claim 19, further comprising:
magnesium in approximately equal weight to the sodium bicarbonate.
